(19) United States
(12) Patent Application Publication
(10) Pub. No.: US 2013/0194635 A1
(43) Pub. Date: Aug. 1, 2013

(54) DATA STORAGE CONTROL APPARATUS, IMAGE FORMING APPARATUS, AND NON-TRANSITORY COMPUTER READABLE MEDIUM

(71) Applicant: Satoshi OKOCHI, Kanagawa (JP)

(72) Inventor: Satoshi OKOCHI, Kanagawa (JP)

(73) Assignee: FUJI XEROX CO., LTD., Tokyo (JP)

(21) Appl. No.: 13/570,981

(22) Filed: Aug. 9, 2012

(30) Foreign Application Priority Data
Jan. 30, 2012 (JP) 2012-016339

(51) Int. Cl. G06K 15/00; G06F 17/30

(52) U.S. Cl. 358/1.16; 707/812; 707/E17.005

(57) ABSTRACT

A data storage control apparatus includes an operation receiving unit that receives an operation to be performed on data, and a generating unit that generates, in a storage area associated with a content of the operation received by the operation receiving unit, data that are a target of the operation received by the operation receiving unit or information relating to the data.

### CROSS-REFERENCE TO RELATED APPLICATIONS

This application is based on and claims priority under 35 USC 119 from Japanese Patent Application No. 2012-016339 filed Jan. 30, 2012.

### BACKGROUND

### Technical Field

The present invention relates to a data storage control apparatus, an image forming apparatus, and a non-transitory computer readable medium.

### SUMMARY

According to an aspect of the invention, a data storage control apparatus is provided. The data storage control apparatus includes an operation receiving unit that receives an operation to be performed on data, and a first generating unit that generates, in a storage area associated with a content of the operation received by the operation receiving unit, data that are a target of the operation received by the operation receiving unit or information relating to the data.

### BRIEF DESCRIPTION OF THE DRAWINGS

An exemplary embodiment of the present invention will be described in detail based on the following figures, wherein:

FIG. 1 is a sectional view of an image forming apparatus as an example of a data storage control apparatus of an exemplary embodiment of the present invention;

FIG. 2 is a block diagram of a hardware configuration of the image forming apparatus;

FIG. 3 is a functional block diagram of the image forming apparatus that is implemented when a program is executed;

FIGS. 4A-4E illustrates a change in a data structure of an external storage medium when the program is executed; and

FIG. 5 is a flowchart illustrating a process flow of the program.

### DETAILED DESCRIPTION

An exemplary embodiment of the present invention is described in detail below.

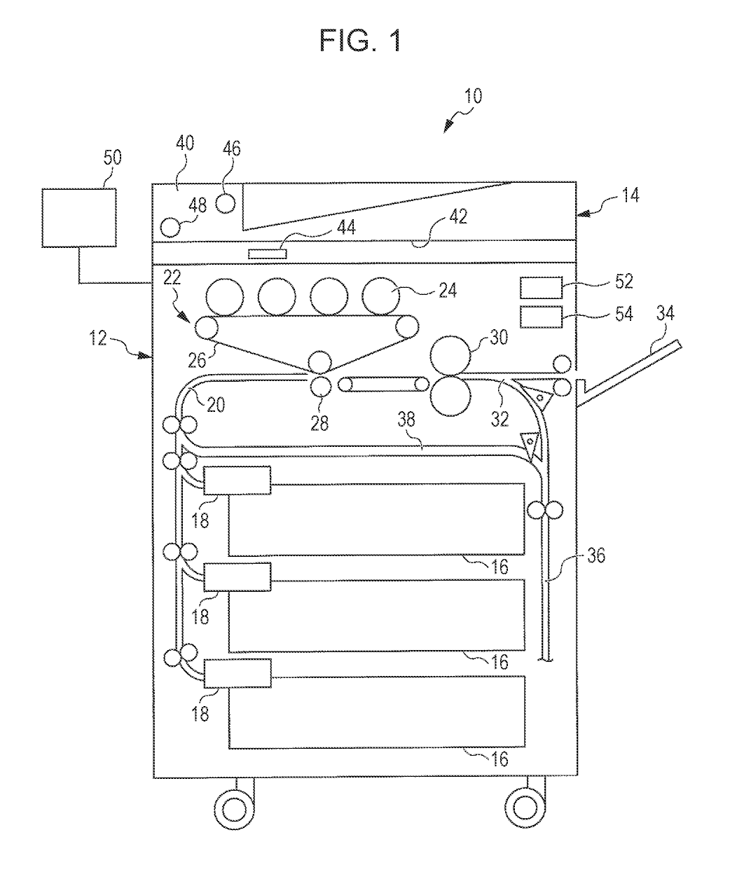

FIG. 1 is a cross-sectional view of an image forming apparatus 10 as an example of a data storage control apparatus of the exemplary embodiment of the present invention.

The image forming apparatus 10 includes a printer 12 and an image reading device 14. The printer 12 includes three recording medium feed cassettes 16 arranged vertically with one cassette above another. Each of the recording medium feed cassettes 16 has a feeder head 18.

If one of the recording medium feed cassettes 16 is selected, the corresponding feeder head 18 operates, feeding a recording medium from the selected recording medium feed cassette 16 to an image forming assembly 22 via a recording medium feeder path 20.

The image forming assembly 22 includes photoconductive members 24 of yellow, magenta, cyan, and black colors, and an intermediate transfer belt 26.

Arranged around each photoconductive member 24 are charging device, exposure device, developing device, first transfer device, and cleaning device (these devices not illustrated). With these devices, a toner image formed on each photoconductive member 24 is transferred to the intermediate transfer belt 26.

A second transfer roll 28 transfers the toner image on the intermediate transfer belt 26 to an incoming recording medium. A fixing device 30 fixes the toner image onto the incoming recording medium. The recording medium having the toner image fixed thereon is discharged to a discharge unit 34 via a recording medium discharge path 32.

If both-side printing is set, the recording medium having a surface image-fixed by the fixing device 30 is transported to a reversing device 36 via the recording medium discharge path 32, and is then reversed by the reversing device 36. The recording medium is then transported to a medium reversing path 38, and returned to the recording medium feeder path 20. The recording medium is transported to the image forming assembly 22 for rear-side printing.

The image reading device 14 includes an automatic document feeder 40 that reads both sides of an original document. The automatic document feeder 40 transports the original document to a platen 42. The original document on the platen 42 is then read by a reading unit 44 including a charge-coupled device (CCD). The image reading device 14 may read an original document placed by a user through the reading unit 44.

The automatic document feeder 40 includes an original document setting detector 46 that detects whether an original document has been set. The automatic document feeder 40 also works as a platen cover. The user may place the original document on the platen 42 by opening the platen cover. The opening of the platen cover is detected by a platen cover opening detector 48.

A user interface device 50 (hereinafter referred to as UI device 50) may be integrated with the image forming apparatus 10 or may be connected to the image forming apparatus 10 via a network. The UI device 50 includes a touchpanel. The UI device 50 may receive as an input an instruction of a process condition input by the user to the image forming apparatus 10, and may display information.

The image forming apparatus 10 includes a facsimile modem 52 connected to a public communication line, and a network communication device 54 that is connected to a network such as a local-area network (LAN). The image forming apparatus 10 transmits and receives facsimile data through the modem 52. Through the network communication device 54, the image forming apparatus 10 transmits an image read by the image reading device 14 to a terminal connected to the network, and receives data from a terminal connected to the network. The image forming apparatus 10 may also transmit and receive e-mails through the network communication device 54.

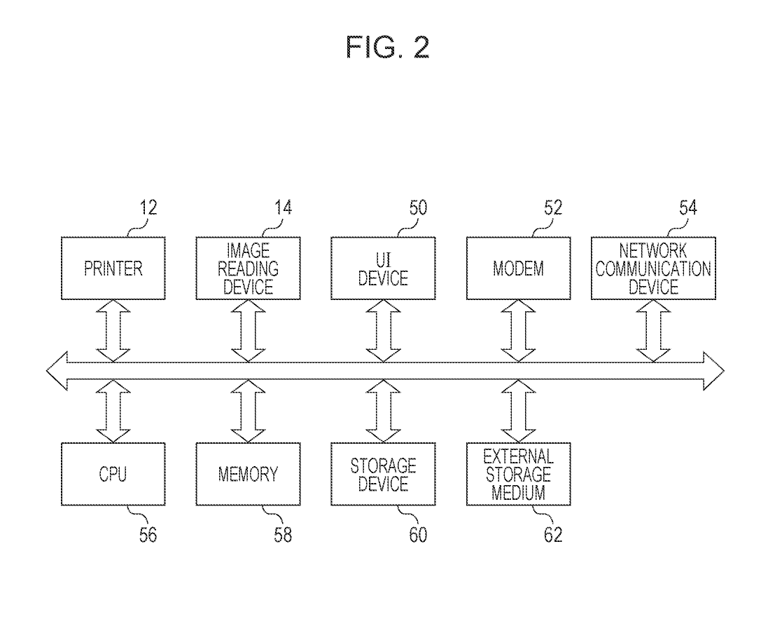

FIG. 2 is a block diagram of a hardware configuration of the image forming apparatus 10.

As illustrated in FIG. 2, the image forming apparatus 10 includes printer 12, image reading device 14, UI device 50, modem 52, and network communication device 54. The image forming apparatus 10 further includes a central processing unit (CPU) 56, memory 58, and storage device 60. All these elements are interconnected via a bus. As illustrated in FIG. 2, a portable external storage medium 62, such as a universal serial bus (USB) memory is connectable to the image forming apparatus 10. The storage device 60 and the external storage medium 62 function as a memory.

The image forming apparatus 10 thus includes the elements as a computer that is communicable with an information processing apparatus or another apparatus.

The CPU 56 controls the operation of the image forming apparatus 10 by executing a program 70 written on one of the memory 58 and the storage device 60. The program 70 is described below. An input received via the UI device 50 is transferred to the CPU 56, and display information is transferred from the CPU 56 to the UI device 50.

The CPU 56 executes the program 70 stored on a recording medium such as a USB memory, or a compact disk-read-only memory (CD-ROM), or may execute the program 70 supplied via the network communication device 54.

The storage device 60 and the external storage medium 62 may store data read by the image reading device 14, or may store data transmitted from a terminal connected to the network.

With this arrangement, the image forming apparatus 10 stores on one of the external storage medium 62 and the storage device 60 the data received via one of the modem 52 and the network communication device 54 and the data read by the image reading device 14. The image forming apparatus 10 also prints the received data through the printer 12. The image forming apparatus 10 also directly receives the data from the external storage medium 62 such as a USB memory, and then prints the received data through the printer 12. The image forming apparatus 10 also facsimile-transmits the data stored on one of the storage device 60 and the external storage medium 62 via the modem 52. The image forming apparatus 10 also transmits the data stored on one of the storage device 60 and the external storage medium 62 via the network communication device 54. The image forming apparatus 10 stores on one of the storage device 60 and the external storage medium 62 data facsimile-received via the modem 52 or data received via the network communication device 54.

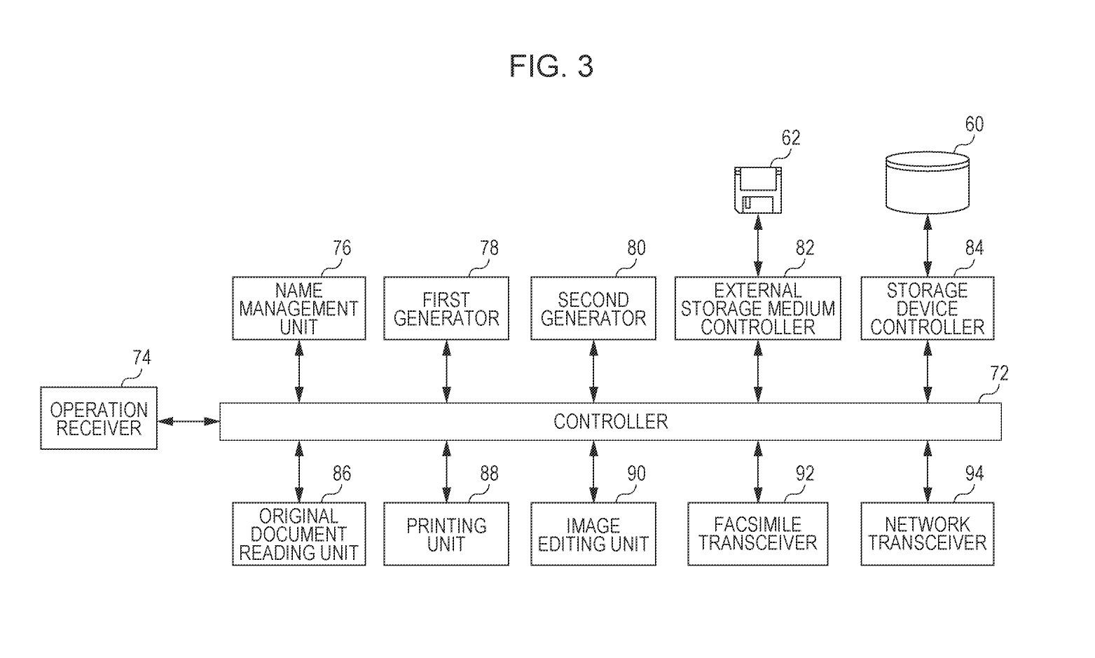

FIG. 3 is a functional block diagram of the image forming apparatus 10 of the exemplary embodiment implemented when the program 70 is executed. Part or whole of the function of the program 70 may be implemented using an application specific integrated circuit (ASIC) arranged on the image forming apparatus 10.

As illustrated in FIG. 3, the image forming apparatus 10 of the exemplary embodiment includes controller 72, operation receiver 74, name management unit 76, first generator 78, second generator 80, external storage medium controller 82, storage device controller 84, original document reading unit 86, printing unit 88, image editing unit 90, facsimile transceiver 92, and network transceiver 94.

The controller 72 controls processes performed by and among the operation receiver 74, the name management unit 76, the first generator 78, the second generator 80, the external storage medium controller 82, the storage device controller 84, the original document reading unit 86, the printing unit 88, the image editing unit 90, the facsimile transceiver 92, and the network transceiver 94.

The operation receiver 74 receives an operation to be performed on data via the UI device 50. The operation to be performed on data corresponds to a function provided by the image forming apparatus 10. The operations include not only an operation to the data stored on one of the storage device 60 and the external storage medium 62, but also an operation to the data that the image forming apparatus 10 is to store on one of the storage device 60 and the external storage medium 62. The functions provided by the image forming apparatus 10 include a function of software installed on the image forming apparatus 10.

The operation receiver 74 receives an operation that reads an original document through the image reading device 14, and stores the read data onto one of the external storage medium 62 and the storage device 60 (hereinafter referred to as a read operation). The operation receiver 74 also receives an operation that prints the data stored on one of one of the external storage medium 62 and the storage device 60 through the printer 12 (hereinafter referred to as a print operation). The operation receiver 74 further receives an operation that facsimile-transmits the data stored on one of the external storage medium 62 and the storage device 60 via the modem 52 (hereinafter referred to as a facsimile transmission operation). The operation receiver 74 further receives an operation that stores data facsimile-received via the modem 52 onto one of the external storage medium 62 and the storage device 60 (hereinafter referred to as a facsimile reception operation). The operation receiver 74 further receives an operation that transmits the data stored on one of the external storage medium 62 and the storage device 60 via the network communication device 54 (hereinafter referred to as a data transmission operation). The operation receiver 74 further receives an operation that stores the data received via the network communication device 54 onto one of the external storage medium 62 and the storage device 60 (hereinafter referred to as a data reception operation).

The data transmission and reception via the network communication device 54 may be performed in a transmission and reception of an e-mail.

The name management unit 76 manages a name assigned to a storage area. The name management unit 76 manages a name associated with each operation received by the operation receiver 74. For example, the name management unit 76 manages names predetermined for respective operations in the form of a table.

The name managed by the name management unit 76 indicates a content of an operation. For example, the name management unit 76 manages the read operation with a name “read” associated therewith, the print operation with a name “printed” associated therewith, the facsimile transmission operation with a name “facsimile transmitted” associated therewith, the facsimile reception operation with a name “facsimile received” associated therewith, the data transmission operation with a name “network transmitted” associated therewith, and the data reception operation with a name “network received” associated therewith.

In the above description, the name management unit 76 manages each operation in association with the name indicating the content of the operation. Optionally, the name management unit 76 may manage each operation in association with the name indicating the content of the operation and including information relating to the operation.

The information relating to the operation includes information relating to setting of the operation, information relating to time of the operation, and information relating to an operator. The name management unit 76 manages an operation in association with at least one of these pieces of information relating to the operation.

In one example, the name management unit 76 manages the read operation that is set to be operative in a monochrome read setting, with name “monochrome read” associated with the read operation.

In another example, the name management unit 76 manages the read operation that is performed in the month Y, the year X, with a name “# read in month Y, year X” associated the read operation.

In another example, the name management unit 76 manages the read operation that is performed by an operator Z as a user, with a name “read (Z)” associated with the read operation.

In another example, an operator having a user name Z transmits facsimile data to address A in the month Y, year X. The name management unit 76 manages the facsimile transmission operation with a name “facsimile-transmitted (Z) to address A in month Y, year X” associated therewith.

The first generator 78 generates information about data that are a target of an operation received by the operation receiver 74, in a storage area associated with the content of the operation received by the operation receiver 74. According to the exemplary embodiment, the first generator 78 generates the information about data that are the target of the operation received by the operation receiver 74, in a storage area generated by the second generator 80 to be described later, as the storage area associated with the content of the operation received by the operation receiver 74. The first generator 78 of the exemplary embodiment generates, as the information about the data serving as the operation target, information that refers to the data serving as the operation target. Optionally, the first generator 78 may generate information indicating a storage location of the data serving as the operation target.

The information that refers to the data serving as the operation target may be shortcut, alias, link, or the like. The information that refers to the data serving as the operation target is different from the data itself, but by referencing the information, the data serving as the operation target is found.

The information indicating the storage location of the data as the operation target may be document data in a text form indicating the storage location of the data.

In place of the information relating to the data as the target of the operation received by the operation receiver 74, the first generator 78 generates data identical in content to the data as the target of the operation received by the operation receiver 74 in a storage area generated by the second generator 80. In such a case, the first generator 78 generates a copy of the data as the target of the operation received by the operation receiver 74 in the storage area generated by the second generator 80.

In this way, the first generator 78 may generate the information referring to the data as the target of the operation, and the data serving the target of the operation. If the information or the data generated in the storage location generated by the second generator 80 is referenced, the data as the target of the operation (the data identical to the data as the target of the operation if the first generator 78 generates the data as the target of the operation) may be referenced.

A size of the storage area in use may be smaller when the first generator 78 generates the information that refers to the data as the target of the operation than when the first generator 78 generates the data as the target of the operation.

The second generator 80 generates a storage area associated with the content of an operation received by the operation receiver 74. According to the exemplary embodiment, the second generator 80 generates the storage area, having a name indicating the content of the operation received by the operation receiver 74, in a storage unit storing the data as the target of the operation. Also according the exemplary embodiment, in response to the operation received by the operation receiver 74, the second generator 80 generates a storage area having a name managed by the name management unit 76 on one of the external storage medium 62 and the storage device 60, each storing the data as the target of the operation. The storage area may include a folder or a directory.

The operation receiver 74 may receive a read operation that stores the data read by the image reading device 14 onto the external storage medium 62. The second generator 80 then generates on the external storage medium 62 a storage area having a name “read” that the name management unit 76 manages as a name associated with the operation.

If the name management unit 76 manages the operation with the name, including the content of the operation and the information relating to the operation, associated with the operation, the second generator 80 generates the storage area, having the name including the content of the operation received by the operation receiver 74 and the information relating to the operation, in the storage unit storing the data as the target of the operation.

The external storage medium controller 82 controls a write process of data onto the external storage medium 62, and a read process of data from the external storage medium 62.

The storage device controller 84 controls a write process of data onto the storage device 60 and a read process of data from the storage device 60.

If the operation receiver 74 receives a read operation, the original document reading unit 86 uses the image reading device 14 to read an original document in accordance with the setting received by the operation receiver 74. In accordance with the setting received by the operation receiver 74, the original document reading unit 86 stores the read data on one of the external storage medium 62 and the storage device 60. The original document reading unit 86 of the exemplary embodiment edits the read data using the image editing unit 90, and then stores the edited data on one of the external storage medium 62 and the storage device 60.

If the operation receiver 74 receives a print operation, the printing unit 88 uses the printer 12 to print the data stored on one of the external storage medium 62 and the storage device 60 in accordance with the setting received by the operation receiver 74. The printing unit 88 of the exemplary embodiment edits the data stored on one of the external storage medium 62 and the storage device 60 using the image editing unit 90, and then prints the edited data using the printer 12.

The image editing unit 90 performs an image process, including noise elimination, on the data read by the original document reading unit 86. The image editing unit 90 also performs the image process, including image forming, on the data to be printed by the printing unit 88. For example, the image editing unit 90 converts image data expressed in a red-green-blue (RGB) color space into image data of cyan (C), magenta (M), yellow (Y), and black (B) colors, and then performs a screen process (halftone process) on the color image data.

If the operation receiver 74 receives a facsimile transmission operation, the facsimile transceiver 92 facsimile-transmits the data stored on one of the external storage medium 62 and the storage device 60 via the modem 52 in accordance with the setting received by the operation receiver 74. If the operation receiver 74 receives a facsimile reception operation, the facsimile transceiver 92 stores on one of the external storage medium 62 and the storage device 60 the data, facsimile-received via the modem 52, in accordance with the setting received by the operation receiver 74.

If the operation receiver 74 receives a data transmission operation, the network transceiver 94 transmits the data stored on one of the external storage medium 62 and the storage device 60 via the network communication device 54 in accordance with the setting received by the operation receiver 74. If the operation receiver 74 receives a data reception operation, the network transceiver 94 stores the data received via the network communication device 54 on one of the external storage medium 62 and the storage device 60 in accordance with the setting received by the operation receiver 74.

The network transceiver 94 may transmit and receive data in the form of an e-mail. In such a case, the name management unit 76 may manage the data transmission operation for data as an e-mail and the data reception operation for data as an e-mail with names “e-mail transmitted” and “e-mail received” respectively associated therewith.

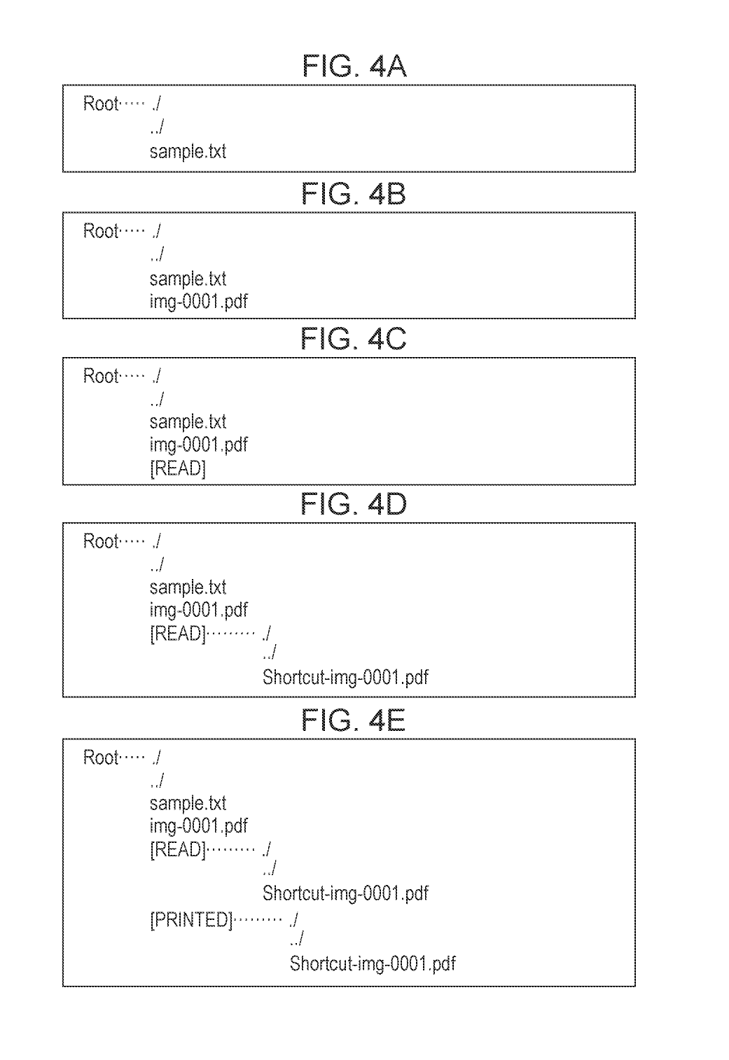

FIGS. 4A-4E illustrate a change in a data structure on the external storage medium 62 responsive to the execution of the program 70. The external storage medium 62 here serves as a storage destination of the data as the target of the operation. The data structure on the storage device 60 is also the same if a storage destination of the data as the target of the operation is the storage device 60.

FIG. 4A illustrates a state of the external storage medium 62 prior to the generation operation of the first generator 78 and the second generator 80.

FIGS. 4B, 4C, and 4D illustrate states of the external storage medium 62 when the operation receiver 74 receives the read operation. It is assumed here that the read operation has been performed in the setting that the read data in a portable document file (PDF) are to be stored on a storage area at a topmost layer of the external storage medium 62.

If the operation receiver 74 receives the read operation, the image reading device 14 reads an original document, and the original document reading unit 86 stores the read data “img-0001.pdf” to the storage area at the topmost layer of the external storage medium 62 as illustrated in FIG. 4B.

As illustrated in FIG. 4C, the second generator 80 generates a storage area having a name “read” in the storage area at the topmost layer of the external storage medium 62, as a storage area having a name indicating the content of the operation received by the operation receiver 74. It is assumed here that the name management unit 76 manages the name “read” as a name associated with the read operation.

As illustrated in FIG. 4D, the first generator 78 generates “shortcut-img-0001.pdf” as reference information (shortcut) to the data “img-0001.pdf” stored by the original document reading unit 86, in the storage area having the name “read” generated by the second generator 80.

FIG. 4E illustrates a state of the external storage medium 62 when the operation receiver 74 receives the print operation in the state of FIG. 4D. It is assumed here that the print operation is to print the data “img-0001.pdf” stored on the storage area at the topmost layer of the external storage medium 62.

If the operation receiver 74 receives a print operation, the second generator 80 generates a storage area having a name “printed,” as a storage area having a name indicating the content of an operation received by the operation receiver 74, within the storage area at the topmost layer of the external storage medium 62 as illustrated in FIG. 4E. The first generator 78 generates “shortcut-img-0001.pdf” as reference information (shortcut) to the data “img-0001.pdf” printed by the printing unit 88, in the storage area having the name “printed” generated by the second generator 80. It is assumed here that the name management unit 76 manages the name “printed” as a name associated with the read operation.

In the above description, the second generator 80 generates the storage area having the name indicating the content of the operation within the storage area at the topmost layer. Alternatively, the second generator 80 may generate the storage area at any predetermined layer in place of the topmost layer.

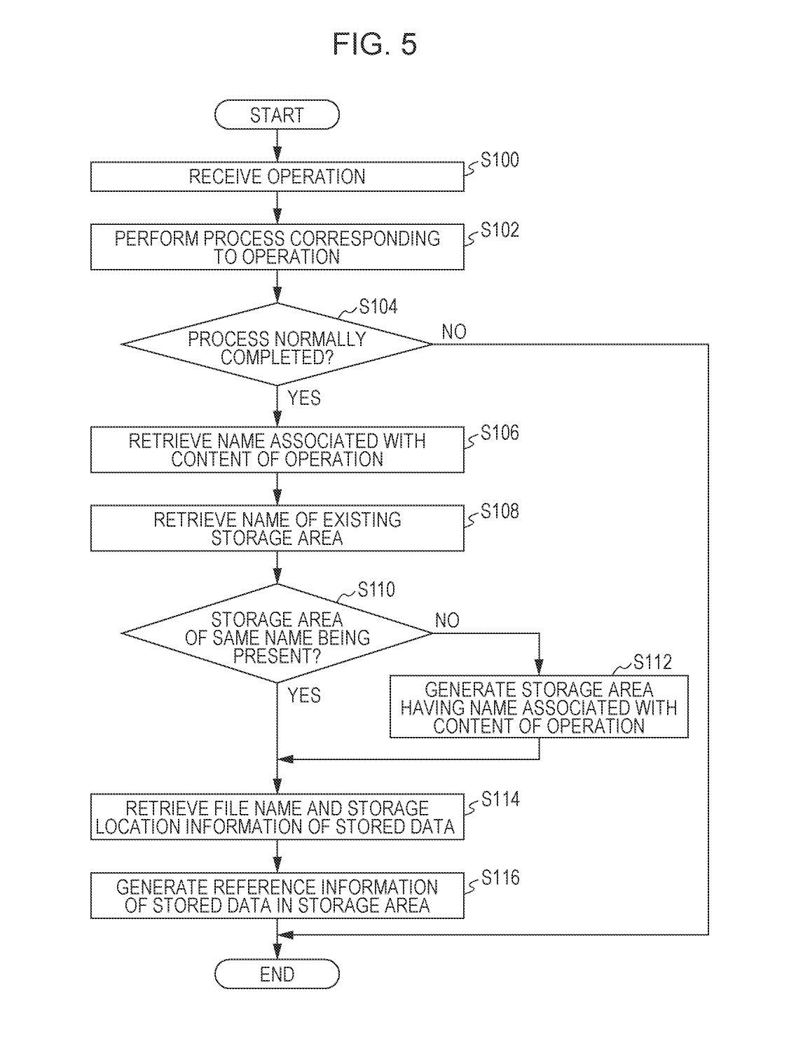

FIG. 5 is a flowchart illustrating a process flow of the program 70.

In step 100 (S100), the operation receiver 74 receives an operation to data via the UI device 50. For example, the operation receiver 74 receives a read operation, or a print operation.

In step 102 (S102), the controller 72 controls the image forming apparatus 10 to perform the operation received by the operation receiver 74. More specifically, the controller 72 controls any element performing a process responsive to the operation received by the operation receiver 74, from among the original document reading unit 86, the printing unit 88, the image editing unit 90, the facsimile transceiver 92, the network transceiver 94, the external storage medium controller 82, and the storage device controller 84. The controller 72 thus causes the element to execute the process.

If the operation receiver 74 receives the read operation to the external storage medium 62, the controller 72 controls the original document reading unit 86, the image editing unit 90, and the external storage medium controller 82, thereby causing the external storage medium 62 to store the read data. If the operation receiver 74 receives the print operation on the data stored on the external storage medium 62, the controller 72 controls the printing unit 88, the image editing unit 90, and the external storage medium controller 82, thereby causing the data stored on the external storage medium 62 to be printed.

In step 104 (S104), the controller 72 determines whether a process corresponding to the operation received by the operation receiver 74 has been normally completed. If the process corresponding to the operation received by the operation receiver 74 has normally completed, processing proceeds to step S106. If any fault occurs, the controller 72 quits the process.

In step 106 (S106), the controller 72 notifies the name management unit 76 of the content of the operation received by the operation receiver 74 and the information relating to the operation. The name management unit 76 notifies the controller 72 of a name associated with the content of the notified operation and the information relating to the information.

If the operation receiver 74 receives a read operation to the external storage medium 62, the controller 72 retrieves the name “read” managed by the name management unit 76. If the operation receiver 74 receives a print operation of the data stored on the external storage medium 62, the controller 72 retrieves a name “printed” managed by the name management unit 76.

In step 108 (S108), the controller 72 issues an instruction to the external storage medium controller 82 or the storage device controller 84, whichever controls the storage unit that stores the data related to the operation received by the controller 72, to retrieve the name of the storage area present in the storage unit. If the external storage medium controller 82 receives the instruction, the external storage medium controller 82 retrieves the name of the storage area present in the external storage medium 62 and then outputs the name to the controller 72. On the other hand, if the storage device controller 84 receives the instruction, the storage device controller 84 retrieves the name of the storage area present in the storage device 60, and then outputs the name to the controller 72.

In step 110 (S110), the controller 72 compares the name of the existing storage area on the storage unit retrieved in step 108 with the name retrieved in step 106, and then determines whether the storage area having the same name is present at a predetermined location (such as the storage area at the topmost layer).

If the controller 72 retrieves the name “read” in step 106 in response to the read operation to the external storage medium 62, the controller 72 determines whether the storage area having the name “read” is present at the storage area at the topmost layer of the external storage medium 62. If the controller 72 retrieves the name “printed” in step 106 in response to the print operation of the data to the external storage medium 62, the controller 72 determines whether the storage area having the name “printed” is present at the storage area at the topmost layer of the external storage medium 62.

If the storage area having the same name as the name retrieved in step 106 is not present in the predetermined location, processing proceeds to step 112. If the storage area having the same name as the name retrieved in step 106 is present in the predetermined location, processing proceeds to step 114.

In step 112 (S112), the controller 72 notifies the second generator 80 of the name retrieved in step 106, and thus instructs the second generator 80 to generate a storage area. The second generator 80 generates a storage area having the name retrieved in step S106 at a predetermine location of the storage unit having stored the data relating to the operation.

For example, if the operation receiver 74 receives the read operation to the external storage medium 62, the second generator 80 generates a storage area having a name “read” within the storage area at the topmost layer of the external storage medium 62. If the operation receiver 74 receives the print operation of the data to the external storage medium 62, the second generator 80 generates a storage area having a name “printed” within the storage area at the topmost layer of the external storage medium 62.

In step 114 (S114), the controller 72 retrieves a file name of data relating to the operation and information of the storage location of the data.

In step 116 (S116), the controller 72 notifies the first generator 78 of the file name and information of the storage location retrieved in step 114, and then instructs the first generator 78 to generate information about data relating to the operation. The first generator 78 generates the information about the data as the target of the operation in the storage area, having the name associated with the operation, generated by the second generator 80.

If the operation receiver 74 receives the read operation to the external storage medium 62, the first generator 78 generates information (shortcut) that refers to the data stored on the external storage medium 62 in the read operation, in the storage area having the name “read” at the topmost layer of the external storage medium 62. For example, if the operation receiver 74 receives the print operation of the data stored on the external storage medium 62, the first generator 78 generates the information (shortcut) that refers to the data as a print target stored on the external storage medium 62, in the storage area having the name “printed” at the topmost layer of the external storage medium 62.

If the same operation has been performed on the same data by multiple times, and if the information relating to the data as the operation target is stored on the storage area having the name associated with the operation, the first generator 78 does not generate the information again.

If pieces of data having the same file name are stored at different storage areas within the same storage unit, the same operation as the operation performed on the one piece of data may be performed on the other piece of data. In such a case, the first generator 78 may generate a shortcut having a name different from the name of the existing shortcut, or may overwrite the existing shortcut. The UI device 50A may display a message asking the user whether to overwrite the existing shortcut, and may select between overwriting the existing shortcut and selecting a different name in response to the user's instruction.

The flowchart has been described. A storage area having a name associated with the content of the operation is generated for each operation. The information relating to the data having served as the target of the operation is generated in the generated storage area.

In the above description, the operations received by the operation receiver 74 include the read operation, the print operation, the facsimile transmission operation, the facsimile reception operation, the data transmission operation, and the data reception operation. The operation received by the operation receiver 74 is not limited to these operations. Any operation received by the operation receiver 74 is acceptable as long as the operation is related to data. The image forming apparatus 10 has been described as one example of a data storage control apparatus. The data storage control apparatus may be a terminal or a server having a function of a computer.

In a terminal or a server having an installed application that edits document data, the operation receiver 74 may receive an edit operation of the document data to be performed by the application. In such a case, the second generator 80 generates the storage area having a name indicating the application, and the first generator 78 generates information that refers to the document data that the application has performed the edit operation on.

In the above description, one of the external storage medium 62 and the storage device 60 serves as a storage destination of the data as the operation target, the generation destination by the first generator 78, and the generation destination by the second generator 80. The exemplary embodiment is not limited to this arrangement. The storage destination and the generation destination may be a storage unit over a network.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data storage control apparatus comprising:
an operation receiving unit that receives an operation to be performed on data; and
a first generating unit that generates, in a storage area associated with a content of the operation received by the operation receiving unit, data that are a target of the operation received by the operation receiving unit or information relating to the data.

2. The data storage control apparatus according to claim 1, comprising a second generating unit that generates a storage area associated with the content of the operation received by the operation receiving unit,
wherein if the operation has been received by the operation receiving unit and no storage area associated with the content of the operation is present, the second generating unit generates a storage area to be associated with the content of the operation.

3. The data storage control apparatus according to claim 1, wherein the first generating unit generates the information that refers to the data that are the target of the operation received by the operation receiving unit.

4. The data storage control apparatus according to claim 2, wherein the first generating unit generates the information that refers to the data that are the target of the operation received by the operation receiving unit.

5. The data storage control apparatus according to claim 2, wherein the operation receiving unit receives a plurality of different operations;
wherein the second generating unit generates a storage area for each operation received by the operation receiving unit; and
wherein the first generating unit generates the data or the information in the storage area associated with the operation received by the operation receiving unit.

6. The data storage control apparatus according to claim 3, wherein the operation receiving unit receives a plurality of different operations;
wherein the second generating unit generates a storage area for each operation received by the operation receiving unit; and
wherein the first generating unit generates the data or the information in the storage area associated with the operation received by the operation receiving unit.

7. The data storage control apparatus according to claim 4, wherein the operation receiving unit receives a plurality of different operations;
wherein the second generating unit generates a storage area for each operation received by the operation receiving unit; and
wherein the first generating unit generates the data or the information in the storage area associated with the operation received by the operation receiving unit.

8. The data storage control apparatus according to claim 2, wherein the second generating unit generates a storage area having a name indicating the content of the operation received by the operation receiving unit.

9. The data storage control apparatus according to claim 3, wherein the second generating unit generates a storage area having a name indicating the content of the operation received by the operation receiving unit.

10. The data storage control apparatus according to claim 4, wherein the second generating unit generates a storage area having a name indicating the content of the operation received by the operation receiving unit.

11. The data storage control apparatus according to claim 5, wherein the second generating unit generates a storage area having a name indicating the content of the operation received by the operation receiving unit.

12. The data storage control apparatus according to claim 6, wherein the second generating unit generates a storage area having a name indicating the content of the operation received by the operation receiving unit.

13. The data storage control apparatus according to claim 2, wherein the second generating unit generates a storage area having a name including the content of the operation and information relating to the operation.

14. The data storage control apparatus according to claim 13, wherein the second generating unit generates a storage area having a name including, as the information relating to the operation, at least one of a piece of information relating to setting of the operation, a piece of information relating to time of the operation, and a piece of information relating to an operator.

15. The data storage control apparatus according to claim 1, wherein the first generating unit generates the data or the information in the storage area if the content of the operation received by the operation receiving unit has been processed normally.

16. The data storage control apparatus according to claim 1, wherein the first generating unit generates the data or the information in a storage area present in a portable storage medium.

17. An image forming apparatus comprising:
a printing unit that prints image data;
an operation receiving unit that receives an operation to be performed on data; and
a first generating unit that generates, in a storage area associated with a content of the operation received by the operation receiving unit, image data that are a target of the operation received by the operation receiving unit or information relating to the image data.

18. The image forming apparatus according to claim 17, comprising a second generating unit that generates a storage area associated with the content of the operation received by the operation receiving unit,
wherein if the operation has been received by the operation receiving unit and no storage area associated with the content of the operation is present, the second generating unit generates a storage area to be associated with the content of the operation.

19. The image forming apparatus according to claim 17, further comprising a reading unit that reads an original document as the image data,
wherein the operation receiving unit receives an operation for the reading unit to read the image data.

20. A non-transitory computer readable medium storing a program causing a computer to execute a process for controlling data storage, the process comprising:
receiving an operation to be performed on data; and
generating, in a storage area associated with a content of the received operation, data that are a target of the received operation or information relating to the data.
